(19) United States
(12) Patent Application Publication
(10) Pub. No.: US 2023/0334339 A1
(43) Pub. Date: Oct. 19, 2023

(54) SUPERVISED AND/OR UNSUPERVISED MACHINE LEARNING MODELS FOR SUPPLEMENTING RECORDS STORED IN A DATABASE FOR RETRIEVAL

(71) Applicant: Capital One Services, LLC, McLean, VA (US)

(72) Inventor: Kevin M. LOWE, Richmond, VA (US)

(21) Appl. No.: 17/659,093

(22) Filed: Apr. 13, 2022

(51) Int. Cl. G06N 5/02; G06N 5/04

(52) U.S. Cl. CPC G06N 5/022; G06N 5/04

(57) ABSTRACT

In some implementations, a system may receive interaction data associated with an interaction between a user and an interaction party. The system may determine, from the interaction data, one or more interaction characteristics associated with the interaction or one or more interaction party characteristics associated with the interaction party, which the system may provide as inputs to a machine learning model trained using supervised learning and historical interactions of the user or one or more other users with the interaction party or one or more other interaction parties. The system may receive an output, based on applying the machine learning model to the interaction data, indicating one or more categories for categorizing the interaction, herein the one or more categories correspond to a subsequent action or recommendation related to the interaction. The system may store a record that includes the interaction data and information identifying the one or more categories.

### BACKGROUND

Machine learning involves computers learning from data to perform tasks. Machine learning algorithms are used to train machine learning models based on sample data, known as “training data.” Once trained, machine learning models may be used to make predictions, decisions, or classifications relating to new observations. Machine learning algorithms may be used to train machine learning models for a wide variety of applications, including computer vision, natural language processing, financial applications, medical diagnosis, and/or information retrieval, among many other examples.

### SUMMARY

Some implementations described herein relate to a system for applying a machine learning model to supplement one or more records stored in a database for retrieval. The system may include one or more memories and one or more processors communicatively coupled to the one or more memories. The one or more memories may be configured to receive, from an interaction party device of an interaction party, of a plurality of interaction parties, interaction data associated with an interaction between a user and the interaction party, wherein the interaction data indicates a user identifier associated with the user. The one or more memories may be configured to determine, from the interaction data, one or more interaction characteristics associated with the interaction or one or more interaction party characteristics associated with the interaction party. The one or more memories may be configured to provide the one or more interaction characteristics and the one or more interaction party characteristics as inputs to the machine learning model, wherein the machine learning model is trained using supervised learning and historical interactions of the user or one or more other users with the interaction party or one or more other interaction parties of the plurality of interaction parties. The one or more memories may be configured to receive an output, based on applying the machine learning model to the interaction data, that indicates one or more categories for categorizing the interaction, wherein the one or more categories correspond to a subsequent action or recommendation related to the interaction. The one or more memories may be configured to store a record, in the database, that includes the interaction data and information that identifies the one or more categories categorizing the interaction.

Some implementations described herein relate to a method of applying a machine learning model to supplement one or more records stored in a database for retrieval. The method may include determining, by a system having one or more processors, one or more actions or recommendations associated with a plurality of interactions between a user and a plurality of interaction parties. The method may include training, by the system, the machine learning model based on interaction data corresponding to historical interactions of the user or one or more other users with one or more of the plurality of interaction parties. The method may include receiving, by the system, outputs based on applying the machine learning model to the interaction data, wherein the outputs indicate one or more categories for categorizing the plurality of interactions, and wherein the one or more categories correspond to the one or more actions or recommendations associated with the plurality of interactions. The method may include storing a plurality of records corresponding to the plurality of interactions, wherein the plurality of records include the interaction data and information that identifies the one or more categories categorizing the plurality of interactions. The method may include receiving, by the system and from a user device of the user, feedback data on at least one of the one or more categories associated with one or more interactions of the plurality of interactions. The method may include retraining, by the system, the machine learning model based on the feedback data.

Some implementations described herein relate to a non-transitory computer-readable medium that stores a set of instructions for managing outbound calling for a device. The set of instructions, when executed by one or more processors of the device, may cause the device to receive, from an interaction party device of an interaction party, of a plurality of interaction parties, interaction data associated with an interaction between a user and the interaction party, wherein the interaction data indicates a user identifier associated with the user. The set of instructions, when executed by one or more processors of the device, may cause the device to determine, from the interaction data, one or more interaction characteristics associated with the interaction or one or more interaction party characteristics associated with the interaction party. The set of instructions, when executed by one or more processors of the device, may cause the device to train a machine learning model using historical interactions of the user or one or more other users with the interaction party or one or more other interaction parties of the plurality of interaction parties. The set of instructions, when executed by one or more processors of the device, may cause the device to receive an output, based on applying the machine learning model to the interaction data, that indicates one or more categories for categorizing the interaction, wherein the one or more categories correspond to a subsequent action or recommendation related to the interaction. The set of instructions, when executed by one or more processors of the device, may cause the device to store a record, in a database, that includes the interaction data and information that identifies the one or more categories categorizing the interaction. The set of instructions, when executed by one or more processors of the device, may cause the device to receive a query, from a user device of the user, that indicates a requested category of the one or more categories. The set of instructions, when executed by one or more processors of the device, may cause the device to retrieve a set of records from the database and based on the query, wherein the set of records includes the record. The set of instructions, when executed by one or more processors of the device, may cause the device to provide the set of records to the user device for display.

### BRIEF DESCRIPTION OF THE DRAWINGS

FIGS. 1A-1D are diagrams of an example implementation relating to supervised and/or unsupervised machine learning models for supplementing records stored in a database for retrieval.

FIG. 2 is a diagram illustrating an example of training and using a machine learning model in connection with supplementing records stored in a database for retrieval.

FIG. 3 is a diagram of an example environment in which systems and/or methods described herein may be implemented.

FIG. 4 is a diagram of example components of one or more devices of FIG. 2.

FIG. 5 is a flowchart of an example process relating to supervised and/or unsupervised machine learning models for supplementing records stored in a database for retrieval.

### DETAILED DESCRIPTION

The following detailed description of example implementations refers to the accompanying drawings. The same reference numbers in different drawings may identify the same or similar elements.

Various applications may utilize records and/or a record log (e.g., a collection of records) to manage and/or provide information associated with the records. For example, a record log may maintain records associated with interactions (e.g., events and/or actions) involving an account associated with the record log. Further, a user may register an account with an application that is configured to maintain a record log for the user. For example, the user may access the record log to review information associated with the interactions in the record. As a more specific example, a banking application may utilize a record log to maintain records of transactions (e.g., credits and/or debits of the account) involving an account registered to a user (e.g., an account holder) of a banking institution or other type of financial institution. In such an example, the user, via the banking application, may review record logs corresponding to financial statements and/or transaction account activity. For example, the user may monitor balances and/or cash flow based on transactions performed using the account. An interaction may include a transaction or an exchange that results in a debit or a credit to the account.

A record of a record log may be generated for an interaction via a system and stored in a database. The system may identify certain interaction data (e.g., metadata) associated with the interaction and/or may generate corresponding record metadata for a record. This metadata may include a time (e.g., timestamp or date) of the interaction, a location of the interaction, an amount associated with the interaction (e.g., an exchange amount, such as a debit or credit amount), and/or an entity (e.g., a merchant and/or vendor) associated with the interaction. However, such records typically are limited to interactions that only involve the particular institution or entity maintaining the record log (e.g., entities with whom the user has a user account). As a result, a user may have record logs of interactions spread across multiple user accounts with different entities or institutions, even though many of the interactions have similarities (e.g., are similar types of interactions). Accordingly, it is desirable to have a system for storing records of interactions across multiple entities with whom a user has separate user accounts, and to organize the records according to similarities between the interactions, such as having a common or similar subsequent action or recommendation.

Some implementations described herein enable a processing system to assist with categorizing interactions by a user with various interaction entities using one or more categories. The one or more categories may be included in information associated with the interaction when the information, which would be limited otherwise, is stored in a database as a record. To enable the processing system to assist with categorizing the interaction, the processing system may receive data based on the interaction (e.g., interaction data) from interaction parties (e.g., via interaction party devices). For example, the interaction data may indicate at least one of an interaction amount or an interaction item type associated with the interaction, or an interaction party type associated with the interaction party. The processing system may store records of the interactions under one or more categories that correspond to subsequent actions or recommendations related to the interactions. Additionally, a user may manually input and/or modify a category (e.g., in a dedicated entry field). The processing system may receive the user-specified category and store a record of the interaction that includes the user-specified category along with the interaction data. Furthermore, the processing system may provide notifications to the user as reminders of the subsequent actions or recommendations to perform and at set dates in advance of a date (e.g., a deadline) associated with the subsequent actions or recommendations.

In some implementations described herein, the processing system may use machine learning to determine suggestions of the one or more categories to provide to the user (e.g., to a user device). For example, the processing system may train a machine learning model using supervised and/or unsupervised learning, along with other variables, such as historical interactions of the user in a particular interaction and/or other users with one or more of the interaction parties and/or previously-received user-specified categories (e.g., user-specified categories included in records stored in the database). The use of machine learning improves the accuracy of the suggestions to the user and creates more uniformity in the categories associated with the records, further improving retrieval of accurate items from the records.

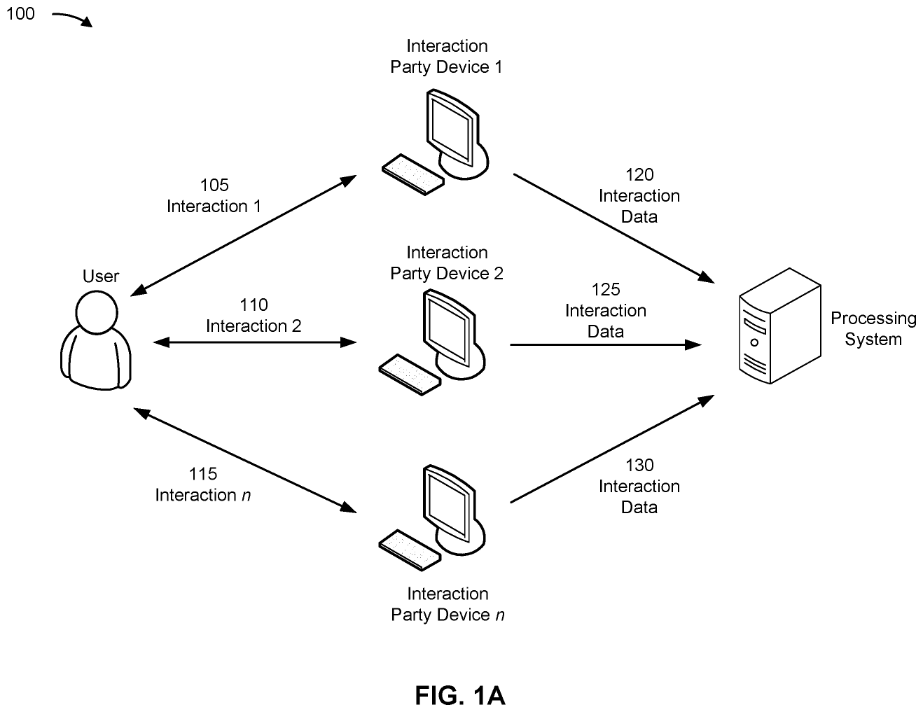

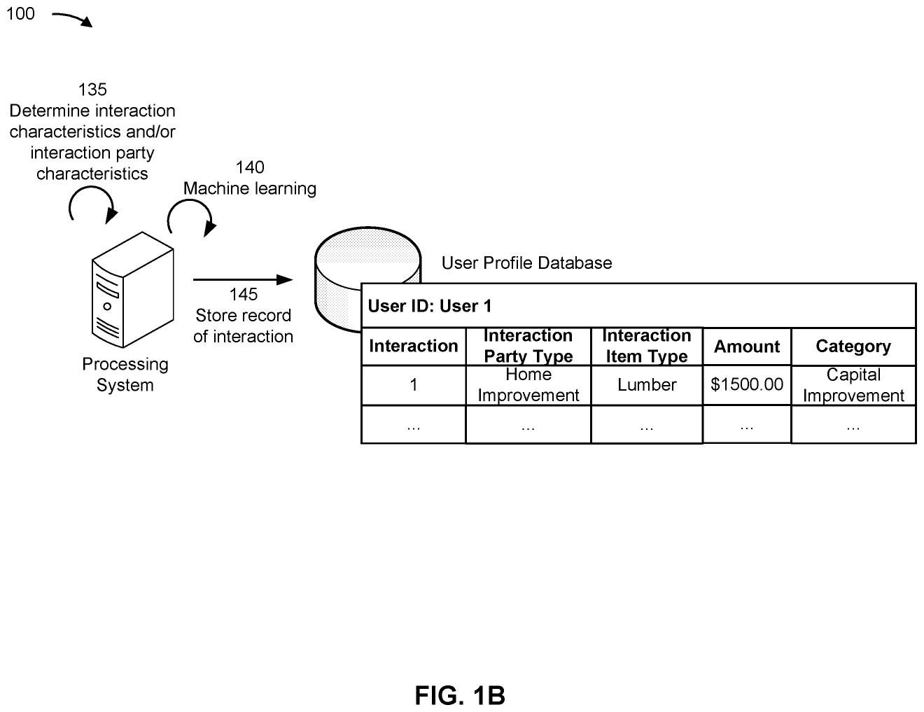

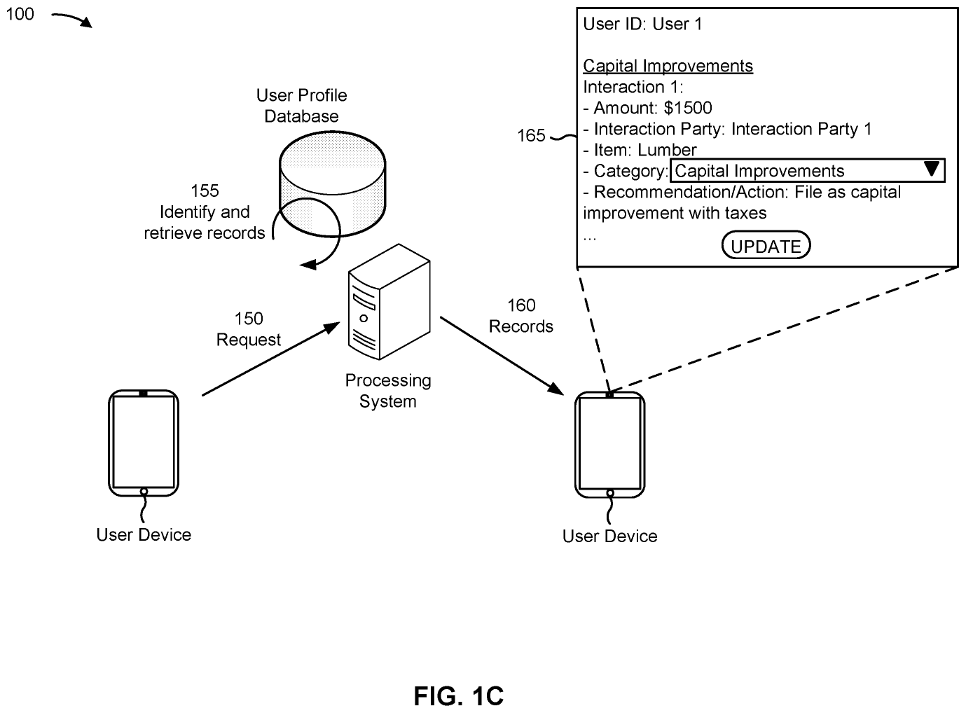

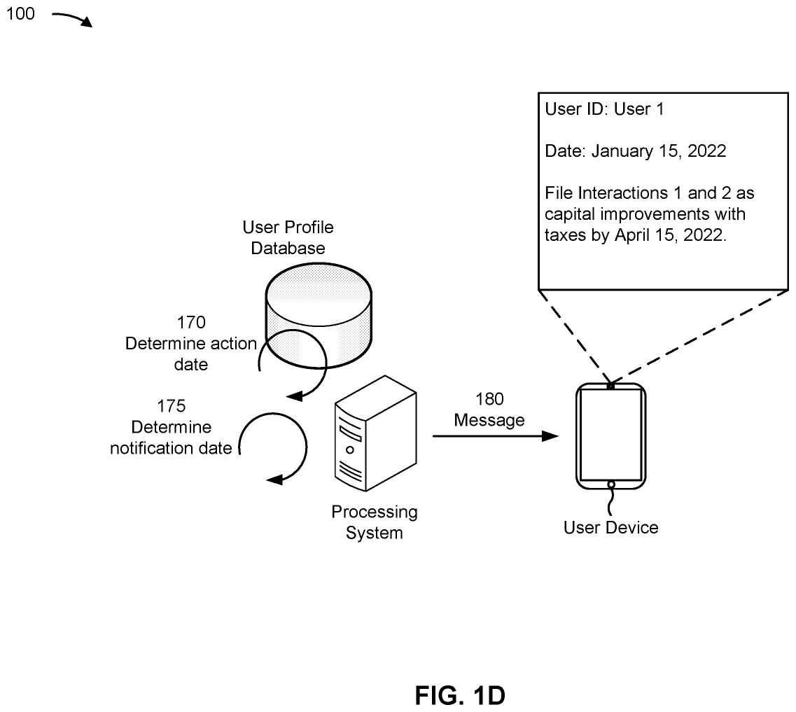

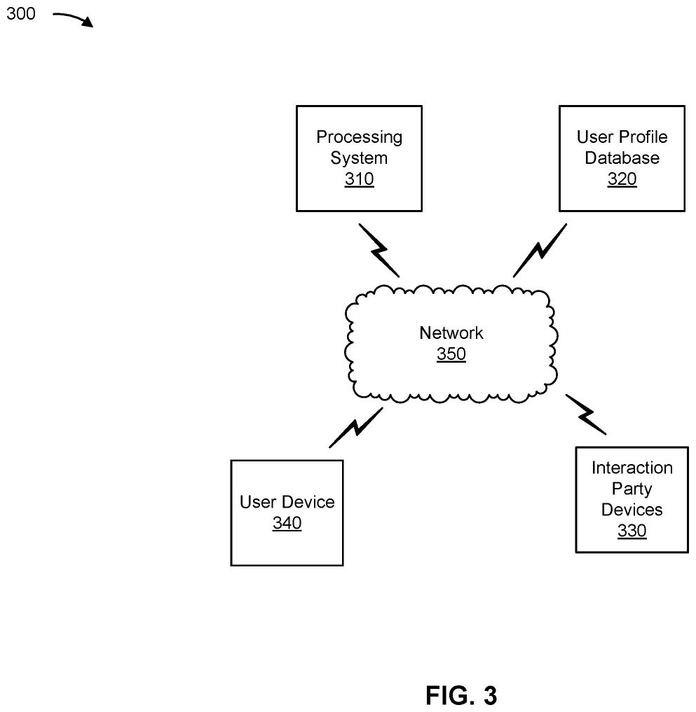

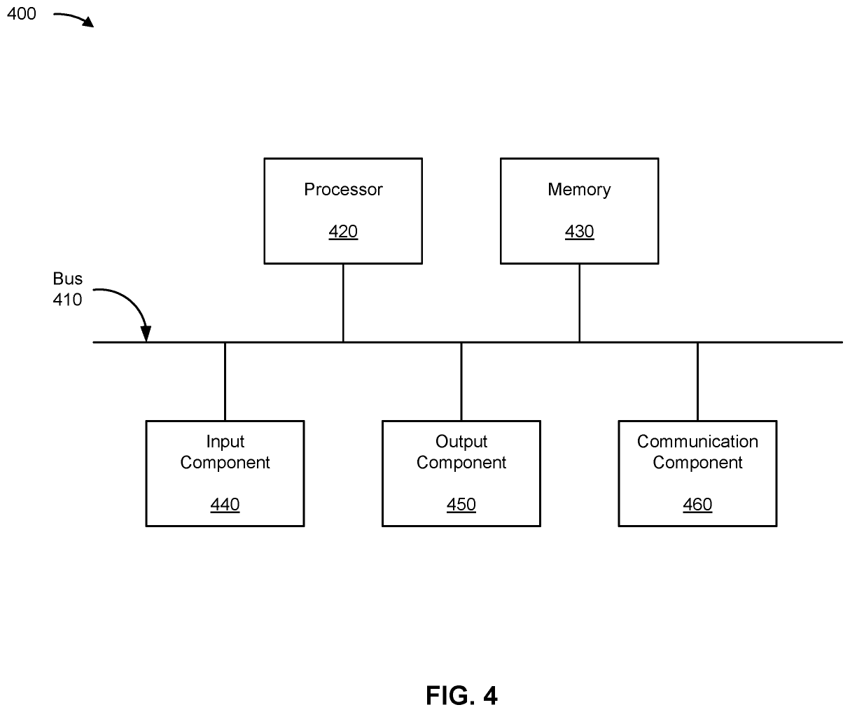

FIGS. 1A-1D are diagrams of an example 100 associated with supervised and/or unsupervised machine learning models for supplementing records stored in a database for retrieval. As shown in FIGS. 1A-1D, example 100 includes a processing system, a user profile database, a user device, a terminal, and an entity profile database. These devices are described in more detail in connection with FIGS. 3 and 4.

As shown in FIG. 1A, a user (e.g., an account holder) may engage in interactions (e.g., exchanges or transactions) with multiple interaction parties (e.g., merchants, vendors, service providers, health care providers, or financial institutions) at different times. For example, a first interaction party may be a merchant and/or a service provider, and a first interaction (e.g., Interaction 1 in FIG. 1A) between the user and the first interaction party may involve the user obtaining a good or a service from the first interaction party. As another example, a second interaction party may be a health care provider, and a second interaction (e.g., Interaction 2 in FIG. 1A) between the user and the second interaction party may involve the user obtaining a health service or procedure (e.g., a consultation, an examination, or an operation). As another example, another interaction party may be a financial institution (e.g., a bank or a credit union), and another interaction (e.g., Interaction n in FIG. 1A) between the user and the additional interaction party may involve the user performing a transaction with the additional interaction party.

As shown in FIG. 1A and by reference numbers 105, 110, and 115, the user may engage with respective devices of the interaction parties (also referred to as interaction party devices) to perform and/or complete the interactions. The user may engage with the interaction party devices via a user device (e.g., via an online interaction) and/or in person. For example, for an interaction with a merchant and/or service provider (e.g., Interaction 1), the interaction party device (e.g., Interaction Party Device 1) may be a point-of-sale (PoS) terminal or system or a transaction kiosk. As another example, for an interaction with a health care provider, the interaction party device (e.g., Interaction Party Device 2) may be a computing device or a server, as described in more detail in connection with FIG. 3. As another example, for an interaction with a financial institution, the interaction party device (e.g., Interaction Party Device n) may be an automated teller machine (ATM).

The interactions may have respective interaction data associated with the interactions. The interaction data may include, but is not limited to, locations (e.g., zip code and/or geographic coordinates) of the interactions and/or locations of the interaction parties, times of the interactions (e.g., timestamps and/or dates), and/or interaction amounts associated with the interaction (e.g., an amount of money exchanged or owed as part of the interaction). Additionally, or alternatively, the interaction data may include an interaction party identifier (e.g., a unique series of alphanumeric characters by which the interaction party may be identified), an interaction party type (e.g., a tag for a type of category in which the interaction party falls), and/or an interaction item (e.g., a particular good, service, or procedure). As shown by reference numbers 120, 125, and 130, the processing system may receive the interaction data from the interaction party devices (e.g., over a network described in more detail below). Additionally, or alternatively, the processing system may receive the interaction data from the user device (e.g., in scenarios in which the user device is used in the interaction). The processing system may also receive, with the interaction data, an account identifier (e.g., an account ID number, a primary account number (PAN), or a virtual card number) associated with the user's account. The processing system may use the account identifier to associate the interaction (e.g., the interaction data) with the user's account.

As shown in FIG. 1B and by reference number 135, the processing system may determine, from the interaction data, one or more interaction characteristics associated with a particular interaction and/or one or more interaction party characteristics associated with the interaction party involved in the particular interaction.

For example, the interaction characteristic may include an interaction item (e.g., an item, such as a good and/or a service, associated with the interaction). In some implementations, the interaction data may indicate the particular interaction item. For example, if the interaction involves a purchase of a good, then the interaction data may specify the good, and the processing system may determine the interaction item directly from the interaction data. Additionally, or alternatively, the processing system may determine the interaction item based on the interaction party identifier received with the interaction data. For example, if the interaction party is a merchant that only sells a particular good (e.g., a lumber store), then the processing system may determine the interaction item based on the interaction party.

In some implementations, the processing system may determine an interaction party type based on the interaction party identifier. For example, the processing system may access an interaction party database in which interaction parties may be categorized and/or tagged with one or more interaction party types (e.g., a hardware store tagged with an interaction party type of “Home Improvement”).

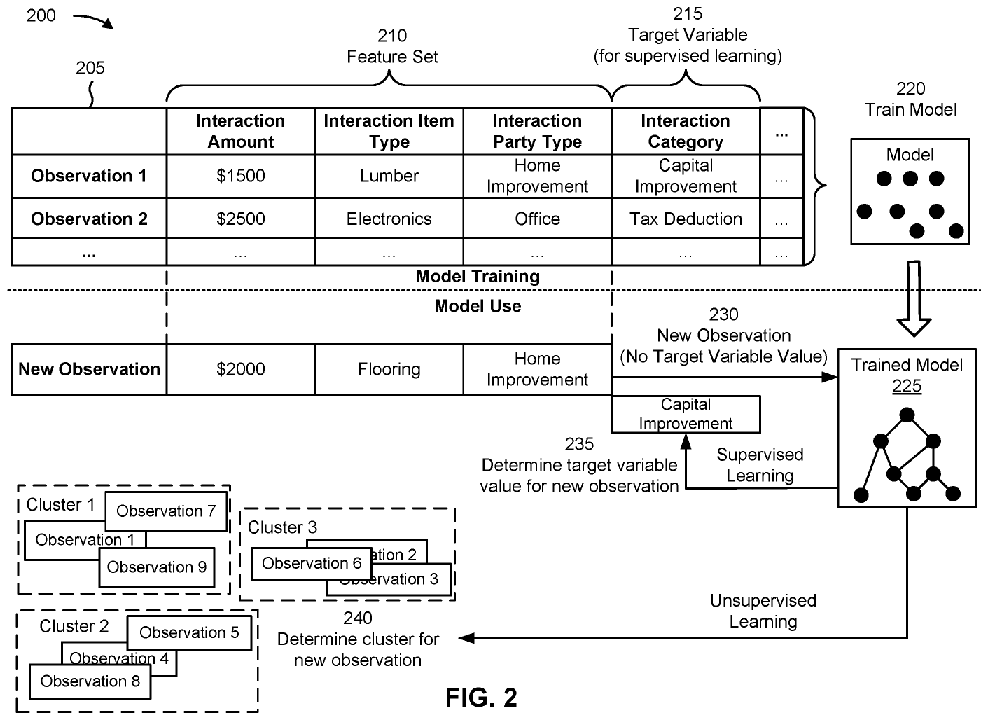

As shown by reference number 140, the processing system may perform machine learning (e.g., train a machine learning model, as described in more detail in connection with FIG. 2 below), using interaction item data (e.g., the interaction characteristic(s) and/or the interaction party characteristic(s)), which the processing system may provide to the machine learning model, to be able to determine categories in future interactions, as described in more detail below. The machine learning model may be trained using supervised and/or unsupervised learning and historical interactions of the user and/or one or more other users with one or more of the interaction parties. For example, the processing system may obtain historical interaction data from records of historical interactions of the user (e.g., interactions with one or more of the interaction parties) stored in the user profile database based on the account identifier associated with the user's account. Additionally, or alternatively, the processing system may obtain historical interaction data from records of historical interactions of the other users (e.g., with the one or more of the interaction parties), which may also be stored in the user profile database, based on user identifiers respectively associated with the other users' accounts. As shown by reference number 145, the processing system may store a record of the interaction (e.g., in a user profile database).

In some implementations, the processing system may provide a notification of the interaction to a user device (e.g., over the network), where details of the interaction may be displayed (e.g., on a display of the user device via the user interface of the mobile application installed on the user device). For example, after receiving the interaction data and account identifier from the terminal, the processing system may identify contact information of the user (sometimes called “user contact information”), such as the user's name, address, phone number, application ID (e.g., associated with the mobile application that executes on the user device), and/or email address, associated with the account identifier and stored under the user's account in the user profile database. The processing system may then transmit the notification to the user based on the contact information (e.g., to the user device as a short message service (SMS) text or an internal message within the mobile application).

In some implementations, the processing system may provide a notification to the user device for every interaction that is detected by the processing system. Alternatively, the processing system may identify specific types of interactions requiring notifications, such as interactions from which interaction characteristics and/or interaction party characteristics were unable to be determined.

Additionally, or alternatively, the processing system may tag certain interactions (e.g., the interaction data) as being unnotified (e.g., no notification was sent to the user for the particular interaction, or a notification was not confirmed as being read). The processing system may provide later access by the user to the interaction data of each of the tagged interactions (e.g., via the mobile application installed and executing on the user device). For example, an interface of the mobile application may display, on the user device, a list of the tagged interactions. For each interaction, the list may include the interaction data or a subset of the interaction data. Additionally, or alternatively, the user may select a particular interaction from the list, which may generate a new interface on the display providing details of the interaction.

In some implementations, the user may be prompted to enter a user-specified category for the interaction (e.g., “Home Improvement”). For example, an entry field, in which the user may input the user-specified category, may be provided for display based on the notification described above. Alternatively, in scenarios in which the user accesses a list of tagged interactions as described above, the entry field may be displayed on the interface resulting from the user's selection of the particular interaction from the list. The user may input information corresponding to the category in the entry field (e.g., via a physical keyboard, a virtual keyboard, or a voice entry). The user may be provided with an option (e.g., in an interface of the mobile application) to skip and/or save for a later time the categorizing of the interaction (e.g., in a scenario in which the user is unsure of a purpose for the interaction with which to categorize the interaction). The processing system may receive information that identifies the user-specified category (or information indicating the user declining to provide a user-specified category) from the user device. The processing system may also receive, with the user-specified category, an interaction identifier associating the user-specified category with the particular interaction. In instances in which the user declined to provide a user-specified category, the processing system may tag the interaction for later access and/or review in a similar manner as described above.

As shown by reference number 145, the processing system may store a record of the interaction in a user profile database under the user's account. The record may include the interaction data (e.g., “Interaction Party Type,” “Interaction Item Type,” and “Amount”) received and/or the information identifying the category (e.g., “Category”), as provided by the user and/or determined by the processing system via the machine learning model. The record may be associated with the interaction identifier received with the category (e.g., “Interaction 1” as shown in FIG. 1B).

The category may correspond to a subsequent action or recommendation related to the interaction. For example, one category may be a tax deductible category (e.g., the interaction items may qualify for a tax deduction). The processing system may have stored (e.g., on its memory) and/or have access to a database of a list of items that may fall under the tax deductible category. As another example, another category may be capital improvements. In such an example, the processing system may have a list of particular items that are commonly used to make capital improvements (e.g., hardware, lumber, metal, and/or other materials).

As shown in FIG. 1C, in some implementations, the user may retrieve the record of the interaction on the user device (e.g., via the mobile application), for example, at some time after the interaction has been completed and the corresponding record stored in the database. As an example, the user device may display, via an interface of the mobile application, a list of tagged interactions, as described above. The user then may be able to select a particular selection from the list, and input a category of the interaction (e.g., if the user declined to provide one earlier at the time of the interaction). Additionally, or alternatively, the user may be able to search a record log of the records of interactions to find a particular interaction for which the user desires to add a category and/or modify an existing category. Additionally, or alternatively, the user, via the user device, may be able to supplement the record with an image corresponding to the interaction. For example, the user may take a photo of a receipt from an interaction, and send (e.g., via the user device) the photo to the processing system. The photo may be stored as part of the record of the interaction in the database. As such, the user may be able to have a more detailed record of the interaction when accessed at a later date.

In some implementations, the processing system and/or the user may be able to divide a particular interaction into multiple sub-interactions in the record stored in the user profile database (e.g., if different goods purchased have different interaction item types and/or if an interaction party has multiple interaction party types, such as an all-purpose merchant). The user may be able to specify interaction data (e.g., time, amount, location, and/or category) for each sub-interaction. For example, the user device may display an interface (e.g., of the mobile application) presenting the record of a particular interaction. The interface may present an option to add a sub-interaction, which the user may select (e.g., by pressing a designated button in the interface). In response, one or more entry fields may be displayed on the interface in which the user may enter the interaction data of the sub-interaction. Alternatively, the interface may have entry fields designated for entry of sub-interactions pre-populated on the display. The processing system may receive data corresponding to the information entered into the entry fields and may store the data with the record in the user profile database.

The processing system may perform machine learning (e.g., train a machine learning model, as described in more detail in connection with FIG. 2 below), using the interaction data and/or the user-specified category, to be able to provide suggestions of categories in future interactions, as described in more detail below. The machine learning model may be trained using supervised and/or unsupervised learning and historical interactions of the user and/or one or more other users with the terminal and/or one or more other terminals. For example, the processing system may obtain historical interaction data from records of historical interactions of the user (e.g., interactions with the terminal and/or other terminals) stored in the user profile database based on the account identifier associated with the user's account. Additionally, or alternatively, the processing system may obtain historical interaction data from records of historical interactions of the other users (e.g., with the terminal and/or other terminals), which may also be stored in the user profile database, based on the account identifiers respectively associated with the users' accounts.

Additionally, or alternatively, the processing system may group or cluster interaction parties having similar characteristics (e.g., using machine learning or one or more rules), and may determine and provide suggested categories based on the cluster. For example, the processing system may group interaction parties within the same geographic area (e.g., same zip code or within a distance threshold of each other) in a cluster. Each interaction party in the cluster may be tagged or identified as being in the cluster in an interaction party profile database. When the processing system receives interaction data for an interaction with a particular interaction party, the processing system may look up, from the interaction party identifier received as part of the interaction data, the cluster of which the interaction party is a part. The processing system may then identify interaction parties in the cluster, and then search the user profile database for interactions involving any interaction party in the cluster. The processing system may then provide suggested categories based on the categories associated with those interactions, such as the most common categories (e.g., those with the greatest number of instances) associated with the cluster of interaction parties, which may be determined based on historical user-specified categories, as described in more detail herein.

As another example, the processing system may obtain the user's interaction history (e.g., transaction history) from a log of records of historical interactions (e.g., transactions) stored in the user profile database, where the interaction data for each interaction indicates one or more categories. The processing system may count the number of instances of each category in the log of records and may suggest the categories with the highest count (e.g., the top 4 categories). The count may be performed across the entire interaction history or a subset of the interaction history (e.g., the past 6 months). Additionally, or alternatively, the processing system may identify a subset of interactions from the interaction history that occur on the same day or group of days (e.g., weekends, a particular day of the week, or a particular day of the month), in a similar time frame as the interaction (e.g., between 7:00 AM and 12:00 PM), and/or in a same month or group of months (e.g., months making up a particular season). The processing system may count the number of instances for each category in the identified subset and may suggest categories with the highest count (e.g., the top 4 categories).

In some implementations, the processing system may determine suggested categories based on the interaction history of other users. For example, the processing system may obtain the other users' interaction history from logs of records of the users' historical interactions, which may also be stored in the user profile database under the users' respective accounts, each account being associated with a respective account identifier. Similar to using the user's own interaction history, the processing system may count the number of instances of each category in the logs of records for all users and may suggest categories with the highest count (e.g., the top 4 categories). Alternatively, the processing system may count the number of instances of each category in the logs of records for a subset of all the users, for example, for users with similar demographic information as the user, where the demographic information for each other user may also be stored in the user profile database under the users' respective accounts. For example, if the user is a male and/or has an age between 21 and 30, then the processing system may count the categories from the records of just male users and/or users between the ages of 21 and 30. The count may be performed across the entire interaction history of each user or a subset of the interaction history (e.g., the past 6 months). Additionally, the processing system may use the interaction history of the user and the other users with any of the rules described above.

Additionally, or alternatively, the processing system may group or cluster users having similar interaction history (e.g., interactions made with the same or similar interaction party, same interaction party type, same or similar times or time periods, and/or similar interaction amounts). For example, the processing system may search records of historical interactions of users (e.g., users or a subset of users) and identify users (e.g., by the account identifier) associated with interaction data indicating interactions with hardware or home improvement stores. As another example, the processing system may identify users associated with interaction data indicating interactions occurring within a particular time period, such as a time of year when home improvements are most likely to be performed (e.g., spring and/or summer). The processing system may cluster users where the number of instances of those interactions satisfies a number threshold.

Additionally, or alternatively, the processing system may group or cluster users having similar characteristics and may determine and provide suggested categories based on the cluster. For example, the processing system may group users with the same demographic information (e.g., sex or age range) in a cluster. Each user in the cluster may be tagged or identified as being in the cluster in the user profile database. When the processing system receives interaction data for an interaction with a particular user, the processing system may look up, from the account identifier received with the interaction data, the cluster of which the user is a part. The processing system may then identify all the users in the cluster, and then search the user profile database for all interactions involving each user in the cluster. The processing system may then provide suggested categories based on the categories associated with those interactions.

The processing system may combine one or more of the implementations described above. For example, the processing system may apply a first factor and/or a first rule (e.g., geographic location of the user) to determine a first set of suggested categories, and then may apply a second factor and/or a second rule to refine and/or narrow the suggested categories. Additionally, or alternatively, the processing system may apply multiple factors and/or rules (e.g., two, three, or more) to determine the suggested categories. The processing system may then provide the refined suggested categories to the user device.

Additionally, or alternatively, the processing system may determine and provide suggested categories based on the machine learning model (e.g., with or without clustering users and/or interaction parties), as described in more detail below in connection with FIG. 2.

In some implementations, as shown in FIG. 1C, the user may be able to retrieve records related to a particular category of interaction (e.g., records that include interaction data with a tag of the category). For example, the user may perform a search of records of past interactions stored in the database (e.g., via the mobile application installed and executing on the user device). The user may input and submit, via the user device, a request for a particular category. For example, the user may manually input and submit the requested category or may select from a set of suggested categories (e.g., as provided via the mobile application, such as in a drop-down list). As shown by reference number 150, the processing system may receive, from the user device, the request. Then, the processing system may search the user profile database for records of interactions that have a same or similar category as the requested category and/or that relate to the requested category. As shown by reference number 155, the processing system may identify and retrieve records based on the request (e.g., records that include and/or relate to the requested category). As shown by reference number 160, the processing system may provide information related to each identified record to the user device for display.

After the record for a particular interaction is displayed on the user device, as shown by reference number 165, the user may update the record. For example, the user may change the interaction category under which the interaction is stored and displayed. As an example, the user may change the interaction category to a manually input category. Alternatively, the user may select an alternative category from a list of pre-defined categories (e.g., from a drop-down menu). The associated action/recommendation may automatically update to an action/recommendation associated with the new interaction category. Additionally, or alternatively, the user may separately change and/or remove the action/recommendation (e.g., in a similar manner as used to change the interaction category. The processing system may use the updated category to re-train the machine learning model, as described in more detail in connection with FIG. 2 below. In some implementations, the processing system may identify one or more other users (also referred to as second users) having second user interaction records of interactions categorized in the same category as the original category from which the user changed the record. The processing system may transmit a notification to the user(s) inquiring whether the user(s) want to update the category. The user(s) may be from a same user cluster as the user, as described in more detail in connection with FIG. 2 below.

In some implementations, as shown in FIG. 1D and by reference number 170, the processing system may determine an action date related to the subsequent action or recommendation. In some scenarios, the processing system may determine the action date based on the category by which the particular interaction was categorized and stored in the user profile database. For example, when the subsequent action or recommendation relates to a tax deduction, the processing system may determine the action date to be the tax filing deadline (e.g., April 15). Additionally, or alternatively, the processing system may determine the action date based on the interaction data associated with the particular interaction. For example, when the subsequent action or recommendation is a deadline to make a payment (e.g., pay a balance associated with an account with the particular interaction party), the action date may be the deadline date.

As shown by reference number 175, the processing system may determine a notification date, based on one or more rules, by which to transmit a notification to the user (e.g., to the user device) related to the subsequent action or recommendation. For example, for a particular action/recommendation (e.g., filing a tax deduction), the notification date may be a set number of days (e.g., 90 days) before the action date (e.g., the tax filing deadline). The notification date may vary for different action dates and/or may be adjustable. Additionally, or alternatively, for a particular action/recommendation, the processing system may transmit multiple notifications each at different notification dates. For example, for a particular action, the notification date may be set at 90 days, 60 days, and 30 days.

As shown by reference number 180, the processing system may transmit, to the user device, the notification, which may be sent, for example, as an in-application message, as electronic mail, and/or as an SMS text message. As shown in FIG. 1D, the message may be displayed on a display or user interface of the user device. In some implementations, from the notification, the user may choose to dismiss the notification completely (e.g., request that no additional notifications for the particular interaction or group of interactions be sent again) or to defer the notification (e.g., request that an additional notification be sent at a set time interval). Additionally, or alternatively, for a particular interaction or group of interactions (e.g., interactions having a same subsequent action or recommendation and/or action date), the user may be able to mark the action as being completed (e.g., in the user account and stored in the user profile database).

Although FIGS. 1A-1D show a single user and suggested categories based on historical input by that user, including interactions with different interaction parties as shown in FIG. 1A, in some implementations, suggested categories for one user (e.g., a first user) may be based on historical input by another user (e.g., a second user) or a group of users (e.g., in a same cluster as the first user). Additionally, implementations described herein may be performed in connection with a mobile application installed and executing on the user device and/or in connection with a web-based application accessible, by the user device, over a network (e.g., a website).

As described above, the processing system enables a user (e.g., account holder) to categorize specific interactions that otherwise would have limited information and/or value associated with the interactions. Through the user-specified categories for the interactions, the records of the interactions are supplemented in a way so as to provide more complete record of interactions that fit into a particular category. Thus, the more complete record improves the database retrieval and results from particular interaction category queries. As such, the user is able to better track and/or monitor activity with the account. Additionally, by categorizing the interactions based on subsequent actions or recommendations, the processing system and/or the user are able to supplement the records stored in a database in a manner that is useful beyond the organization of the records in the database.

As indicated above, FIGS. 1A-1D are provided as an example. Other examples may differ from what is described with regard to FIGS. 1A-1D.

FIG. 2 is a diagram illustrating an example 200 of training and using a machine learning model in connection with supplementing records stored in a database for retrieval. The machine learning model training and usage described herein may be performed using a machine learning system. The machine learning system may include or may be included in a computing device, a server, a cloud computing environment, or the like, such as the processing system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from a user device, one or more interaction party devices, a processing system, and/or a user profile database, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the user device, the interaction party device(s), the processing system, and/or the user profile database. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include an interaction amount (e.g., an amount associated with a particular interaction), an interaction item type (e.g., a type of item involved in the particular interaction), an interaction party type (e.g., a type or category of the interaction party involved in the interaction with the user), and so on. As shown, for a first observation, the first feature may have a value of “$1500,” the second feature may have a value of “Lumber,” the third feature may have a value of “Home Improvement,” and so on. These features and feature values are provided as examples and may differ in other examples. For example, the feature set may include one or more of the following features: demographic information of the user, a location of the user (e.g., zip code and/or geographic coordinates), a location of the interaction and/or the interaction party (e.g., zip code and/or geographic location), and/or an interaction history of the user (e.g., all interactions of the user using one or more accounts associated with the user, and/or interactions within a particular time period, such as the most recent year, the most recent 6 months, the most recent month, or the like).

In some implementations, the observations used to train a machine learning model may be user-specific. For example, a machine learning model may be trained for and/or applied to a particular user, and the observations may be based on interactions (e.g., transactions) associated with that particular user. Alternatively, the observations used to train a machine learning model may be associated with other users (e.g., other account holders from the same financial institution) obtained from the user profile database and associated with respective account identifiers. For example, the observations may be based on interactions of all users having records stored in the user profile database. Alternatively, the observations may be based on interactions of a subset of users, such as one or more clusters of users to which the user in the interaction belongs (e.g., based on specific common characteristics, as described below). Thus, the processing system and/or the machine learning system may train multiple machine learning models for different users and/or clusters of users and may select a machine learning model to be applied to determine suggested categories for a user based on the user and/or a cluster to which the user belongs.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is an interaction category with which to categorize and/or under which to store interaction data associated with the particular interaction, which has a value of “Capital Improvement” for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of “$2000,” a second feature of “Flooring,” a third feature of “Home Improvement,” and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example of a supervised learning model, the trained machine learning model 225 may predict a value of “Capital Improvement” for the interaction category for the new observation, as shown by reference number 235. Based on this prediction, the machine learning system may provide a first recommendation. The first recommendation may include, for example, one or more suggested categories for an interaction between the user and the interaction party (e.g., via the interaction party device). In some implementations, the machine learning model may determine, for each category of multiple categories, a probability that the interaction is associated with that category. For example, the machine learning model may determine a first probability that the interaction is associated with a first category, a second probability that the interaction is associated with a second category, and so on. The machine learning model may output a set of categories for which a corresponding set of probabilities satisfy a threshold. These categories may be used by the processing system as the suggested categories that are indicated to the user device, as described above in connection with FIG. 1B.

In some implementations, the processing system and/or the machine learning system may train and/or apply an unsupervised machine learning model, such as to cluster users or to cluster interaction parties. To cluster users, the observations may include demographic information and/or interactions histories of the users, among other examples. To cluster interaction parties, the observations may include an interaction party locations and/or interaction party types. In these cases, the output of the machine learning model may include information that identifies a cluster to which a new observation belongs and/or information that indicates a degree of similarity between the new observation and one or more other observations. As an example of an unsupervised learning model, the trained machine learning model 225 may classify (e.g., cluster) the new observation in a cluster, as shown by reference number 240. The observations within a cluster may have a threshold degree of similarity. For example, the interaction parties in the cluster of interaction parties may all have locations in a same geographic area (e.g., in the same zip code) or interaction party type (e.g., a home improvement store). As another example, the users in the cluster of users may have the same or similar demographic information (e.g., sex, age, or age range) or may have the same or similar pattern of interactions (e.g., interactions at similar times and/or in similar categories based on the historical interaction data of the users).

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include a new interaction category input by the user (e.g., user input data via the user device) for a particular interaction of the historical interactions.

In this way, the machine learning system may apply a rigorous and automated process to provide suggestions of categories for interactions between the user and the interaction party device. The machine learning system enables recognition and/or identification of tens, hundreds, thousands, or millions of features and/or feature values for tens, hundreds, thousands, or millions of observations, thereby increasing accuracy and consistency and reducing delay associated with providing suggestions of categories for interactions between the user and the interaction party device relative to requiring computing resources to be allocated for tens, hundreds, or thousands of operators to manually provide suggestions of categories for interactions between the user and the interaction party device using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a processing system 310, a user profile database 320, interaction party devices 330, a user device 340, and a network 350. Devices of environment 300 may interconnect via wired connections, wireless connections, or a combination of wired and wireless connections.

The processing system 310 includes one or more devices capable of receiving, generating, storing, processing, providing, and/or routing information associated with presentation and control of user interactions with a time-dependent user interface element, as described elsewhere herein. The processing system 310 may include a communication device and/or a computing device. For example, the processing system 310 may include a server, such as an application server, a client server, a web server, a database server, a host server, a proxy server, a virtual server (e.g., executing on computing hardware), or a server in a cloud computing system. In some implementations, the processing system 310 includes computing hardware used in a cloud computing environment.

The user profile database 320 includes one or more devices capable of receiving, generating, storing, processing, and/or providing information associated with supplementing records stored in a database for retrieval, as described elsewhere herein. The user profile database 320 may include a communication device and/or a computing device. For example, the user profile database 320 may include a data structure, a database, a data source, a server, a database server, or a similar type of device. As an example, the user profile database 320 may store user information, including a user identifier and contact information of the user, and/or account information, including one or more account identifiers associated with one or more interaction parties, records of interactions completed by a user (e.g., interaction data and one or more categories associated with the interaction), as described elsewhere herein. Additionally, the user profile database 320 may store user information and/or account information of multiple other users, and records of interactions completed by the other users.

The interaction party devices 330 include one or more devices capable of receiving, generating, storing, processing, and/or providing information associated with performing interactions, as described elsewhere herein. The interaction party devices 330 may include communication devices and/or computing devices. For example, the interaction party devices 330 may include a wireless communication device, a mobile phone, a laptop computer, a tablet computer, a desktop computer, or a similar type of device.

Additionally, or alternatively, the interaction party devices 330 include one or more devices capable of facilitating an interaction (e.g., an exchange or transaction) with a user (e.g., an account holder). For example, the interaction party devices 330 may include an ATM, a kiosk (e.g., a financial service kiosk), a secure access terminal (e.g., a terminal equipped with an encrypted connection to a server and/or database), a point-of-sale (PoS) terminal, and/or a payment terminal (e.g., a credit card terminal, a contactless payment terminal, a mobile credit card reader, or a chip reader). The interaction party devices 330 may include one or more input components and/or one or more output components to facilitate obtaining data (e.g., account information) from a physical medium (e.g., a transaction card, a mobile device executing a banking application, or the like) and/or to facilitate interaction with the user. Example input components of the interaction party devices 330 include a number keypad, a touchscreen, a magnetic stripe reader, a chip reader, and/or a radio frequency (RF) signal reader (e.g., a near field communication (NFC) reader). Example output devices of the interaction party devices 330 include a display and/or a speaker.

The user device 340 includes one or more devices capable of receiving, generating, storing, processing, and/or providing information associated with supplementing records stored in a database for retrieval, as described elsewhere herein. The user device 340 may include a communication device and/or a computing device. For example, the user device 340 may include a wireless communication device, a mobile phone, a laptop computer, a tablet computer, a desktop computer, or a similar type of device.

The network 350 includes one or more wired and/or wireless networks. For example, the network 350 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 350 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to the processing system 310, the user profile database 320, the interaction party devices 330, and/or the user device 340. In some implementations, the processing system 310, the user profile database 320, the interaction party devices 330, and/or the user device 340 include one or more devices 400 and/or one or more components of device 400. As shown in FIG. 4, device 400 may include a bus 410, a processor 420, a memory 430, an input component 440, an output component 450, and a communication component 460.

Bus 410 includes one or more components that enable wired and/or wireless communication among the components of device 400. Bus 410 may couple together two or more components of FIG. 4, such as via operative coupling, communicative coupling, electronic coupling, and/or electric coupling. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform one or more operations or processes described elsewhere herein.

Memory 430 includes volatile and/or nonvolatile memory. For example, memory 430 may include random access memory (RAM), read only memory (ROM), a hard disk drive, and/or another type of memory (e.g., a flash memory, a magnetic memory, and/or an optical memory). Memory 430 may include internal memory (e.g., RAM, ROM, or a hard disk drive) and/or removable memory (e.g., removable via a universal serial bus connection). Memory 430 may be a non-transitory computer-readable medium. Memory 430 stores information, instructions, and/or software (e.g., one or more software applications) related to the operation of device 400. In some implementations, memory 430 includes one or more memories that are coupled to one or more processors (e.g., processor 420), such as via bus 410.

Input component 440 enables device 400 to receive input, such as user input and/or sensed input. For example, input component 440 may include a touch screen, a keyboard, a keypad, a mouse, a button, a microphone, a switch, a sensor, a global positioning system sensor, an accelerometer, a gyroscope, and/or an actuator. Output component 450 enables device 400 to provide output, such as via a display, a speaker, and/or a light-emitting diode. Communication component 460 enables device 400 to communicate with other devices via a wired connection and/or a wireless connection. For example, communication component 460 may include a receiver, a transmitter, a transceiver, a modem, a network interface card, and/or an antenna.

Device 400 may perform one or more operations or processes described herein. For example, a non-transitory computer-readable medium (e.g., memory 430) may store a set of instructions (e.g., one or more instructions or code) for execution by processor 420. Processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, processor 420 may be configured to perform one or more operations or processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

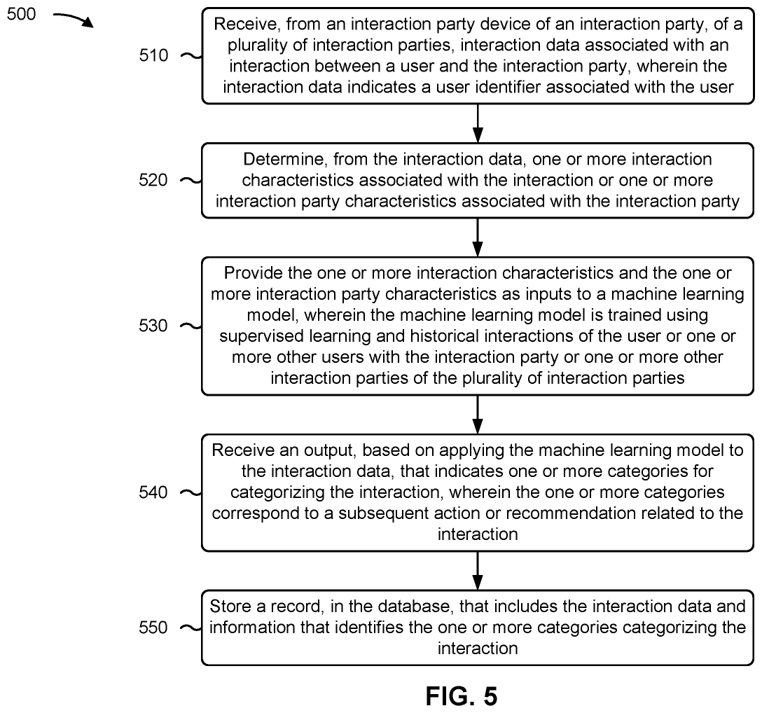

FIG. 5 is a flowchart of an example process 500 associated with supervised and/or unsupervised machine learning models for supplementing records stored in a database for retrieval. In some implementations, one or more process blocks of FIG. 5 may be performed by a system (e.g., processing system 310). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving, from an interaction party device of an interaction party, of a plurality of interaction parties, interaction data associated with an interaction between a user and the interaction party, wherein the interaction data indicates a user identifier associated with the user (block 510). For example, the processing system 310 (e.g., using processor 420, memory 430, input component 440, and/or communication component 460) may receive, from an interaction party device of an interaction party, of a plurality of interaction parties, interaction data associated with an interaction between a user and the interaction party, wherein the interaction data indicates a user identifier associated with the user, as described above in connection with reference numbers 120, 125, and 130 of FIG. 1A. As an example, the processing system may receive the interaction data from the interaction party devices (e.g., over a network described in more detail below). The processing system may also receive, with the interaction data, an account identifier (e.g., an account ID number, a PAN, or a virtual card number) associated with the user's account. The processing system may use the account identifier to associate the interaction (e.g., the interaction data) with the user's account.

As further shown in FIG. 5, process 500 may include determining, from the interaction data, one or more interaction characteristics associated with the interaction or one or more interaction party characteristics associated with the interaction party (block 520). For example, the processing system 310 (e.g., using processor 420 and/or memory 430) may determine, from the interaction data, one or more interaction characteristics associated with the interaction or one or more interaction party characteristics associated with the interaction party, as described above in connection with reference number 135 of FIG. 1B. As an example, the processing system may determine, from the interaction data, one or more interaction characteristics (e.g., interaction item and/or interaction party type), associated with a particular interaction and/or one or more interaction party characteristics associated with the interaction party involved in the particular interaction.

As further shown in FIG. 5, process 500 may include providing the one or more interaction characteristics and the one or more interaction party characteristics as inputs to a machine learning model, wherein the machine learning model is trained using supervised learning and historical interactions of the user or one or more other users with the interaction party or one or more other interaction parties of the plurality of interaction parties (block 530). For example, the processing system 310 (e.g., using processor 420 and/or memory 430) may provide the one or more interaction characteristics and the one or more interaction party characteristics as inputs to the machine learning model, wherein the machine learning model is trained using supervised learning and historical interactions of the user or one or more other users with the interaction party or one or more other interaction parties of the plurality of interaction parties, as described above in connection with reference number 200 of FIG. 2. As an example, the processing system may perform machine learning (e.g., train a machine learning model, as described in more detail in connection with FIG. 2 below), using interaction item data (e.g., the interaction characteristic(s) and/or the interaction party characteristic(s)), which the processing system may provide to the machine learning model, to be able to determine categories in future interactions.

As further shown in FIG. 5, process 500 may include receiving an output, based on applying the machine learning model to the interaction data, that indicates one or more categories for categorizing the interaction, wherein the one or more categories correspond to a subsequent action or recommendation related to the interaction (block 540). For example, the processing system 310 (e.g., using processor 420, memory 430, input component 440, and/or communication component 460) may receive an output, based on applying the machine learning model to the interaction data, that indicates one or more categories for categorizing the interaction, wherein the one or more categories correspond to a subsequent action or recommendation related to the interaction, as described above in connection with reference number 200 of FIG. 2.

As further shown in FIG. 5, process 500 may include storing a record, in the database, that includes the interaction data and information that identifies the one or more categories categorizing the interaction (block 550). For example, the processing system 310 (e.g., using processor 420 and/or memory 430) may store a record, in the database, that includes the interaction data and information that identifies the one or more categories categorizing the interaction, as described above in connection with reference number 145 of FIG. 1B. As an example, the processing system may store a record of the interaction (e.g., in a user profile database).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1D.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for applying a machine learning model to supplement one or more records stored in a database for retrieval, the system comprising:
one or more memories; and
one or more processors, communicatively coupled to the one or more memories, configured to:
receive, from an interaction party device of an interaction party, of a plurality of interaction parties, interaction data associated with an interaction between a user and the interaction party, wherein the interaction data indicates a user identifier associated with the user;
determine, from the interaction data, one or more interaction characteristics associated with the interaction or one or more interaction party characteristics associated with the interaction party;
provide the one or more interaction characteristics and the one or more interaction party characteristics as inputs to the machine learning model, wherein the machine learning model is trained using supervised learning and historical interactions of the user or one or more other users with the interaction party or one or more other interaction parties of the plurality of interaction parties;
receive an output, based on applying the machine learning model to the interaction data, that indicates one or more categories for categorizing the interaction, wherein the one or more categories correspond to a subsequent action or recommendation related to the interaction; and
store a record, in the database, that includes the interaction data and information that identifies the one or more categories categorizing the interaction.

2. The system of claim 1, wherein the one or more processors are further configured to:
receive a query that indicates a requested category of the one or more categories;
retrieve a set of records from the database and based on the query, wherein the set of records includes the record; and
provide the set of records to a user device for display.

3. The system of claim 1, wherein the one or more interaction characteristics include an interaction item, and
wherein the one or more processors are further configured to:
determine an interaction item type associated with the interaction item; and
provide, to the machine learning model, interaction item data indicating the interaction item type.

4. The system of claim 1, wherein the one or more interaction party characteristics include an interaction party identifier associated with the interaction party in the interaction, and
wherein the one or more processors are further configured to:
identify an interaction party type of the interaction party based on the interaction party identifier; and
provide, to the machine learning model, interaction party data indicating the interaction party type.

5. The system of claim 1, wherein the interaction data indicates an interaction amount associated with the interaction, and
wherein the one or more processors are further configured to:
provide, to the machine learning model, the interaction amount.

6. The system of claim 1, wherein the one or more processors are further configured to:
determine an action date related to the subsequent action or recommendation related to the interaction;
determine a notification date based on the action date, wherein the notification date is a time frame from the action date; and
transmit, to a user device of the user and by the notification date, a message indicating the action date and the subsequent action or recommendation.

7. The system of claim 1, wherein the one or more processors are further configured to:
transmit, to a user device of the user, an instruction that causes the user device to provide an entry field for display;
receive, from the user device and after transmitting the instruction, a message indicating a user-specified category for categorizing the interaction,
wherein the user-specified category indicated by the message is different from the one or more categories indicated by the output received based on applying the machine learning model to the interaction data; and
update the record associated with the interaction to include information that identifies the user-specified category.

8. The system of claim 7, wherein the one or more processors are further configured to retrain the machine learning model based on the user-specified category.

9. The system of claim 7, wherein the one or more processors are further configured to:
identify a second user, of the one or more other users, having a second user interaction record associated with an interaction categorized with at least one same category as the record; and
transmit, to a second user device of the second user, a message inquiring if the second user wants to update the second user interaction record to include the user-specified category.

10. The system of claim 1, wherein the one or more processors are further configured to:
receive, from a user device, an input corresponding to an image associated with the interaction; and
determine the one or more interaction characteristics from the image.

11. A method of applying a machine learning model to supplement one or more records stored in a database for retrieval, comprising:
determining, by a system having one or more processors, one or more actions or recommendations associated with a plurality of interactions between a user and a plurality of interaction parties;
training, by the system, the machine learning model based on interaction data corresponding to historical interactions of the user or one or more other users with one or more of the plurality of interaction parties;
receiving, by the system, outputs based on applying the machine learning model to the interaction data, wherein the outputs indicate one or more categories for categorizing the plurality of interactions, and wherein the one or more categories correspond to the one or more actions or recommendations associated with the plurality of interactions;
storing a plurality of records corresponding to the plurality of interactions, wherein the plurality of records include the interaction data and information that identifies the one or more categories categorizing the plurality of interactions;
receiving, by the system and from a user device of the user, feedback data on at least one of the one or more categories associated with one or more interactions of the plurality of interactions; and
retraining, by the system, the machine learning model based on the feedback data.

12. The method of claim 11, further comprising:
training the machine learning model trained using unsupervised learning to determine a cluster of users to which the user belongs, the cluster of users being based on at least one of:
demographic information of the users in the cluster; or
historical interaction data of the users in the cluster,
wherein the historical interactions used to train the machine learning model are based on the cluster of users.

13. The method of claim 11, further comprising:
determining, for one or more of the plurality of interactions, an action date related to one of the one or more actions or recommendations associated with the plurality of interactions; and
transmitting, to the user device and within a time frame from the action date, a message indicating the action date and the one of the one or more actions or recommendations for the one or more of the plurality of interactions.

14. The method of claim 11, wherein receiving the feedback data from the user device comprises:
receiving, from the user device, user input data indicating a user-specified category for categorizing the one or more interactions of the plurality of interactions, wherein the user-specified category is different from the at least one of the one or more categories.

15. The method of claim 14, further comprising:
updating one or more of the plurality of records, associated with the at least one of the one or more categories, to include information that identifies the user-specified category.

16. A non-transitory computer-readable medium storing a set of instructions for managing outbound calling, the set of instructions comprising:
one or more instructions that, when executed by one or more processors of a device, cause the device to:
receive, from an interaction party device of an interaction party, of a plurality of interaction parties, interaction data associated with an interaction between a user and the interaction party, wherein the interaction data indicates a user identifier associated with the user;
determine, from the interaction data, one or more interaction characteristics associated with the interaction or one or more interaction party characteristics associated with the interaction party;
train a machine learning model using historical interactions of the user or one or more other users with the interaction party or one or more other interaction parties of the plurality of interaction parties;
receive an output, based on applying the machine learning model to the interaction data, that indicates one or more categories for categorizing the interaction, wherein the one or more categories correspond to a subsequent action or recommendation related to the interaction;
store a record, in a database, that includes the interaction data and information that identifies the one or more categories categorizing the interaction;
receive a query, from a user device of the user, that indicates a requested category of the one or more categories;
retrieve a set of records from the database and based on the query, wherein the set of records includes the record; and
provide the set of records to the user device for display.

17. The non-transitory computer-readable medium of claim 16, wherein the one or more instructions, when executed by the one or more processors, further cause the device to:
transmit, to the user device, an instruction that causes the user device to provide an entry field for display;
receive, from the user device and after transmitting the instruction, a message indicating a user-specified category for categorizing the interaction,
wherein the user-specified category indicated by the message is different from the one or more categories indicated by the output received based on applying the machine learning model to the interaction data; and
update the record associated with the interaction to include information that identifies the user-specified category.

18. The non-transitory computer-readable medium of claim 17, wherein the one or more instructions, when executed by the one or more processors, further cause the device to retrain the machine learning model based on the user-specified category.

19. The non-transitory computer-readable medium of claim 16, wherein at least one of:
the one or more interaction characteristics include an interaction item, or
the one or more interaction party characteristics include an interaction party identifier associated with the interaction party in the interaction.

20. The non-transitory computer-readable medium of claim 16, wherein the one or more instructions, when executed by the one or more processors, further cause the device to:
determine an action date related to the subsequent action or recommendation related to the interaction; and
transmit, to the user device and within a time frame from the action date, a message indicating the action date and the subsequent action or recommendation.
